(19) United States
(12) Patent Application Publication
(10) Pub. No.: US 2015/0226114 A1
(43) Pub. Date: Aug. 13, 2015

(54) ROTARY ENGINE

(71) Applicant: JUNG-KUANG CHOU, NEW TAIPEI CITY 220 (TW)

(72) Inventor: JUNG-KUANG CHOU, NEW TAIPEI CITY 220 (TW)

(21) Appl. No.: 14/693,944

(22) Filed: Apr. 23, 2015

Related U.S. Application Data
(63) Continuation-in-part of application No. 13/555,267, filed on Jul. 23, 2012.
Application No. 13/555,267 is a continuation-in-part of application No. 12/827,121, filed on Jun. 30, 2010, now abandoned.
Application No. 12/827,121 is a continuation-in-part of application No. 12/382,585, filed on Mar. 19, 2009, now abandoned.
Application No. 12/382,585 is a continuation-in-part of application No. 11/649,308, filed on Jan. 4, 2007, now abandoned.
Application No. 11/649,308 is a continuation-in-part of application No. 11/114,059, filed on Apr. 26, 2005, now abandoned.
Application No. 11/114,059 is a continuation-in-part of application No. 10/900,192, filed on Jul. 28, 2004, now abandoned.
Application No. 10/900,192 is a continuation-in-part of application No. 10/392,859, filed on Mar. 21, 2003, now abandoned.

(51) Int. Cl. F02B 53/06; F02B 53/12; F02B 53/10

(52) U.S. Cl. CPC F02B 53/06; F02B 53/10; F02B 53/12

(57) ABSTRACT

A rotary engine for generator, automobile, locomotive, airplanes, ships, vehicle or motorcycle is provided. The rotary engine comprises a rotor and at least one supporting member. The rotor rotates around an axis and has at least one chamber with a door selectively close the chamber; the supporting member approaches the rotor and has a first fuel inlet, a spark plug and a groove disposed sequentially along with the rotated direction of the rotor. The groove has an outlet connecting to exterior of the fixing member. Wherein the first fuel inlet allows fuel entering and approaching the chamber, and then the spark plug ignites the fuel of the chamber when the chamber and the groove are connected.

### CROSS-REFERENCE TO RELATED APPLICATION

This U.S. Non-provisional application for patent is a continuation-in-part (CIP) application of patent application Ser. No. 13/555,267 filed on 23 Jul. 2012, currently pending, Ser. No. 12/827,121 filed on Jan. 30, 2010, abandoned, Ser. No. 12/382,585 filed on Mar. 19, 2009, abandoned, Ser. No. 11/649,308 filed on 4 Jan. 2007, abandoned, Ser. No. 11/114,059 filed on 26 Apr. 2005, abandoned, Ser. No. 10/900,192 filed on 28 Jul. 2004, abandoned, and Ser. No. 10/392,859 filed on 21 Mar. 2003, abandoned. The entirety of each of the above-mentioned patent applications is hereby incorporated by reference herein and made as a part of this specification.

### BACKGROUND OF THE INVENTION

1. Field of the Invention

The present invention relates to an engine, and particularly relates to an engine having at least one rotary combustion chamber for intake, combustion, explosion and exhaust, so as to drive the rotor to rotate and provide the mechanical torque.

2. Description of Related Art

Conventionally, the engine has a cylinder piston repeatedly movable inside a chamber, such that combustion and explosion of the fuel gas may take place during the interior volume expansion and compression. In the ignition, combustion and exhaust; therefore the piston is able to be driven to move and the mechanical force is generated to utilize.

However, such interior combustion engine only has 35% of energy conversion rate in maximum; that means huge energy consumption is wasted.

### SUMMARY OF THE INVENTION

The primary object of the present invention is to have another type of engine, so as to improve conversion rate of the engine.

The rotary engine comprises a rotor, rotating around an axis and having at least one chamber with a door selectively close the chamber; one supporting member approaching the rotor and having at least one inlet, at least one nozzle, and a groove disposed sequentially along with the rotated direction of the rotor, the groove having an outlet connecting to exterior of the fixing member, the nozzle connected between the air inlet and the groove, wherein the groove adjust the rotor and face to the chamber of the rotor, and the door approaching the groove, the door opened and rotated to a position which can contacted and gasket to the groove; at least one sealing component disposed between the supporting member and approaching the rotor, the sealing component is infixed at periphery of the supporting member or at periphery of the groove, and the sealing component has a plate and at least one spring pushing the plate to seal up the rotor; wherein the inlet allows a working gas entering the groove and approaching the chamber; and pushed the door and the rotor to rotated.

One of the embodiments according to the rotary engine, wherein supporting member approaching the rotor and having a inlet, a fuel intake, a spark plug and a groove disposed sequentially along with the rotated direction of the rotor, the groove having an outlet connecting to exterior of the fixing member, the inlet and the fuel intake connected to a preparative chamber, the inlet conducting a compress air into the preparative chamber, and the fuel intake guiding a fuel into the preparative chamber, the fuel and the compressed air are mixed into a mixture gas, the preparative chamber disposed on the inner sidewall of the supporting member, thus when the chamber of the rotor cross over the preparative chamber, the mixture gas inject into the chamber; wherein the groove adjust the rotor and face to the chamber of the rotor, and the door approaching the groove, the door opened and rotated to a position which can contacted and gasket to the groove; at least one sealing component disposed between the supporting member and approaching the rotor, the sealing component is infixed at periphery of the supporting member or at periphery of the groove, and the sealing component has a plate and at least one spring pushing the plate to seal up the rotor. Wherein the chamber approaching the groove, the mixture gas carried by the chamber flow into the groove and ignited by the spark plug, the door is pushed and rotated by an explosion made from the mixture gas, the door contacted and gasket to the groove, thus the door and the rotor pushed by the explosion made from the mixture gas.

One of the embodiments according to the rotary engine, wherein the door is pivotally connected to the chamber.

One of the embodiments according to the rotary engine, wherein the door is disposed at outmost of the chamber.

One of the embodiments according to the rotary engine, wherein the spark plug is disposed near the groove or at the periphery of the groove.

One of the embodiments according to the rotary engine, wherein the fixing member has at least one tuning component to adjust the location of the supporting member, and the tuning component drives the supporting member to move axially or radially.

One of the embodiments according to the rotary engine, wherein the rotary engine further has a guide to drive the door to close when the door approaches the supporting member and in due course.

Summarily, the rotary engine of the present invention utilize three steps (i.e. fuel entering, spark plug ignition, and gas exhaust) to convert chemical energy into mechanical force, so that the rotary engine can have better energy efficiency rather than traditional engine.

For further understanding of the present invention, reference is made to the following detailed descriptions illustrating the embodiments and examples of the present invention. The descriptions are for illustrative purpose only and should not be intended to limit the scope of the claim.

### BRIEF DESCRIPTION OF THE DRAWINGS

The drawings included herein provide a further understanding of the present invention. A brief introduction of the drawings is as follows:

FIG. 1 shows a perspective view of the 1st embodiment according to the present disclosure;

FIG. 1A shows a perspective view of a rotor for a rotary engine according to the present disclosure;

FIG. 2 shows a cross-sectional view of the 1st embodiment according to the present disclosure;

FIG. 3A-3C show the cross-sectional view of the operation process of the 2nd embodiment according to the present disclosure;

FIG. 4 shows a perspective view of the 3rd embodiment according to the present disclosure;

FIG. 5 shows a cross-sectional view of the 3rd embodiment according to the present disclosure;

### DETAILED DESCRIPTION OF PREFERRED EMBODIMENTS

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art.

### 1st Embodiment

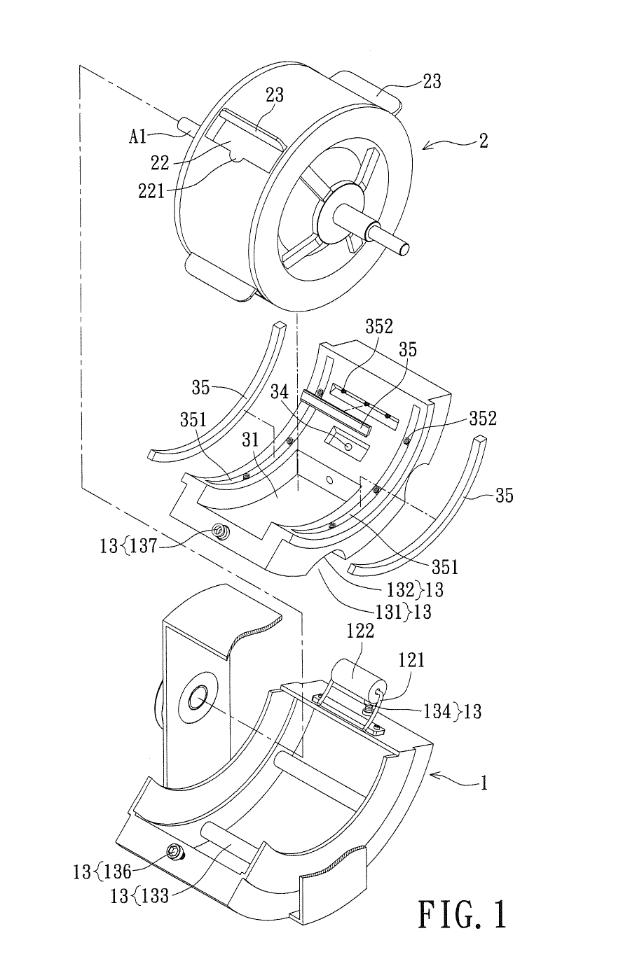

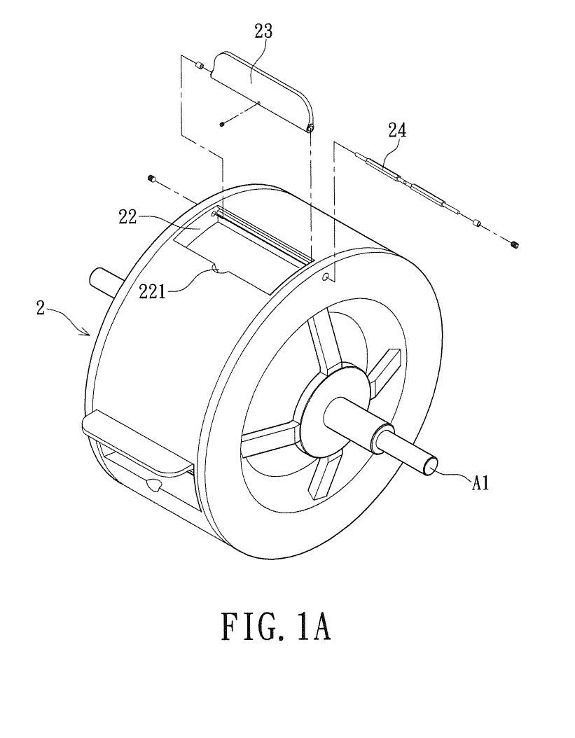

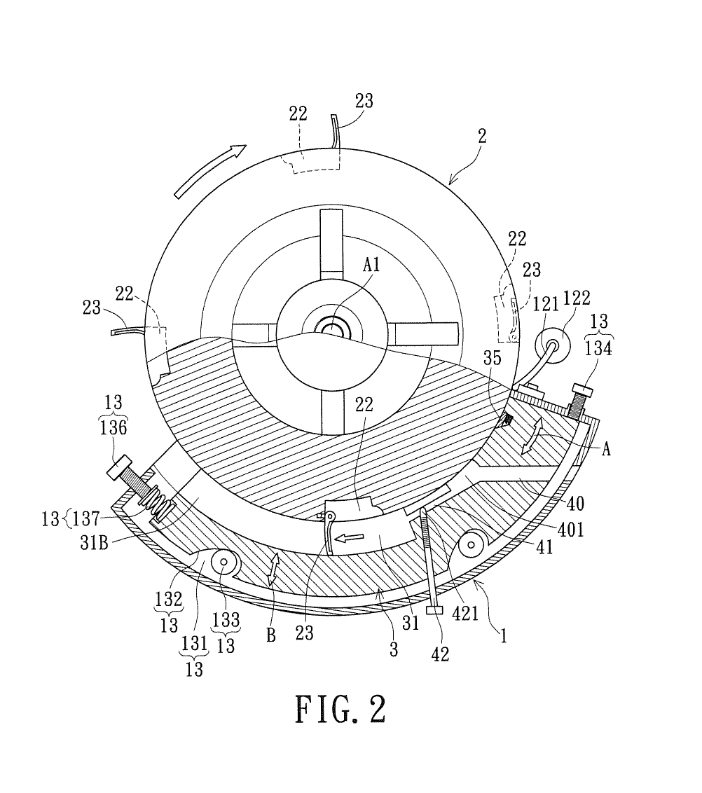

Please refer to FIG. 1 and FIG. 2, a rotary engine is utilized for a turbine machine which is drive by a working gas such as compressed air, steam, or combustion gas. As the FIG. 1 showing, the first embodiment of the rotary engine comprises a rotor 2 and a supporting member 3. The rotor 2 rotates around an axis A1 and has at least one chamber 22 disposed at radial edge of the rotor 2. In this embodiment, the number of the chamber 22 is 4, and four chambers 22 are evenly spaced circumferentially along with the axis A1; i.e. the adjacent chambers 22 are 90 degree spaced to each other. Each chamber 22 has a U-shaped door 23 pivotally connected to the chamber 22 (shown in FIG. 1A), so that the door 23 can be selectively closed the chamber 22 by rotation around a shaft 24. In preferable embodiment, the door 23 or the shaft 24 are disposed at outmost of the chamber 22. Each of the chamber 22 has a conducting valley 221 disposed at surrounding of the chamber 22.

The supporting member 3 is disposed at radial side of the rotor 2, and approaches the rotor 2 (i.e. next to the rotor 2). Moreover, the supporting member 3 has an inlet 40, a nozzle 41, a pin valve 42, and a groove 31 disposed sequentially along with the rotated direction of the rotor 2 (by clockwise direction as shown in FIG. 2). The end of the inlet 40 connected to a preparative chamber 401; the nozzle 41 is connected between the preparative chamber 401 and the groove 31. The end portion of the pin valve 42 is extended into the nozzle 41 to adjust the air flow of the nozzle 41.

The inlet 40 guides the working gas into the preparative chamber 401, thus the chamber 22 approach the preparative chamber 401, the working gas injected into the chamber 22. Moreover the working gas is flows into the groove 31 through the nozzle 41 to drive the door 23 and the rotor 2.

The groove 31 further has an outlet 31B disposed at outer edge of the supporting member 3 and connected to exterior of the fixing member 1. In preferable embodiment, the supporting member 3 is positioned by a fixing member 1, so as to combine the rotor 2 with the supporting member 3. The rotary engine further has a guide 121 disposed on the fixing member 1, in which the guide 121 having a roller 122 which is corresponded to the rotation path of the door 23. The guide 121 and the roller 122 may be preferably disposed at edge of the fixing member 1.

As shown in FIG. 2, when the rotor 2 rotates clockwise, the chamber 22 and the door 23 approached the guide 121 and the roller 122. When the door 23 approaches to the supporting member 3, the door 23 may driven to rotate counter-clockwise by the guide 121 and roller 122, so as to close the chamber 22, therefore the door 23 can pass through the inner side of the supporting member 3.

As the FIG. 2 showing, the groove 31 is adjusted to the rotor 2 and face to the chamber 22 of the rotor 2, thus when the door 23 approaching the groove 31 and departs the inner side of the supporting member 3, the door 23 is pushed by the working gas and rotated to a position which can contacted and gasket to the inner wall of the groove 31, therefore the door 23 is pushed by the working gas inside the groove 31 and drives the rotor 2 rotated by clockwise direction.

Additionally as shown in FIG. 1 and FIG. 2, the fixing member 1 has at least one tuning component 13, in order to meet a slightly contact location between the rotor 2 and the supporting member 3 for smooth rotation, while the material expansion or contract has being occur, in which the tuning component 13 drives the supporting member 3 to move in a circular direction or radial direction. In this embodiment, the tuning component 13 include a first adjusting screw 134 mounted on one end of the fixing member 1, a second adjusting screw 136 mounted on the other end of the fixing member 1, and a spring 137 disposed between the second adjusting screw 136 and the supporting member 3. Thus screwing the second adjusting screw 136 can press the spring 137 and force the supporting member 3 move toward to the first adjusting screw 134, so as to do a fine position of the supporting member 3 in a circular direction (by the direction of arrow A as shown in FIG. 2).

Moreover the tuning component 13 having a plurality of cam slots 131 disposed on the radial edge of the supporting member 3, a plurality of rollers 133 are mounted on the fixing member 1 and engaged in the inner side of the cam slots 131. Each of the cam slots 131 having a inclined curved surface 132 and each of the roller 133 is adjusted the curved surface 132, thus when the supporting member 3 pushed by the second adjusting screw and force the spring 137, the curved surface 132 pushed to the roller 133, and the component force generated by the curved surface 132 and the roller 133 force the supporting member 3 move axially and adjacent the rotor 2 (by the direction of arrow B as shown in FIG. 2), so as to ensure that the supporting member 3 and the rotor 2 are closely attached and adjusting the clearance between the supporting member 3 and the rotor 2, to regulate by a first adjusting screw 134

In preferable embodiment as shown in FIG. 1, the supporting member 3 has at least one sealing component 35 infixed at periphery of the supporting member 3, so that the sealing components 35 may engage the rotor 2 when the rotor 2 is rotated. More specifically, the sealing components 35 are disposed between the rotor 2 and the supporting member 3, and therefore selectively seal up the chamber 22 and the groove 31. As showing in the FIG. 1, the sealing components 35 is disposed in a plurality of slots 351 disposed on the inner side of the supporting member 3, and several spring 352 disposed in the slots 351, so that the springs 352 can push the plate 35 to tightly seal up the rotor 2 and the supporting member 3. Summarily, the sealing components 35 may have diversified profiles.

### 2nd Embodiment

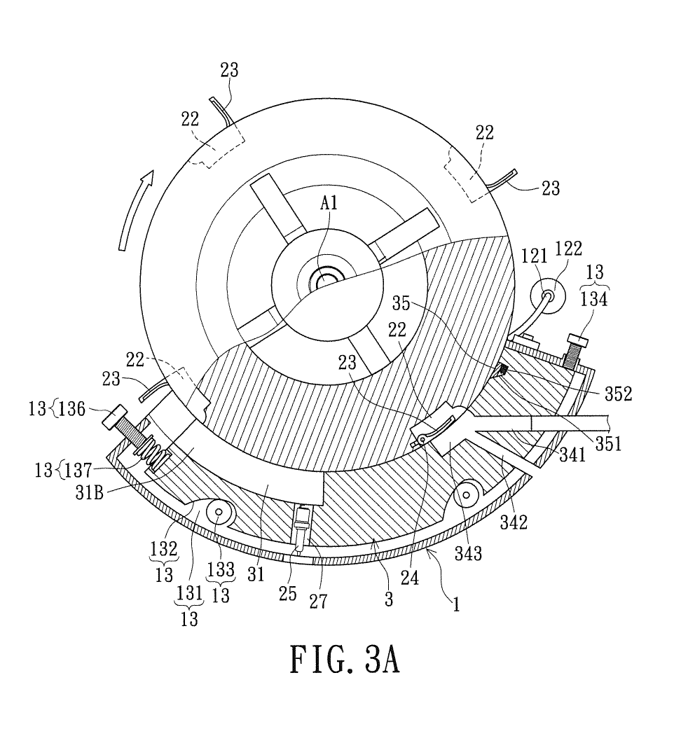

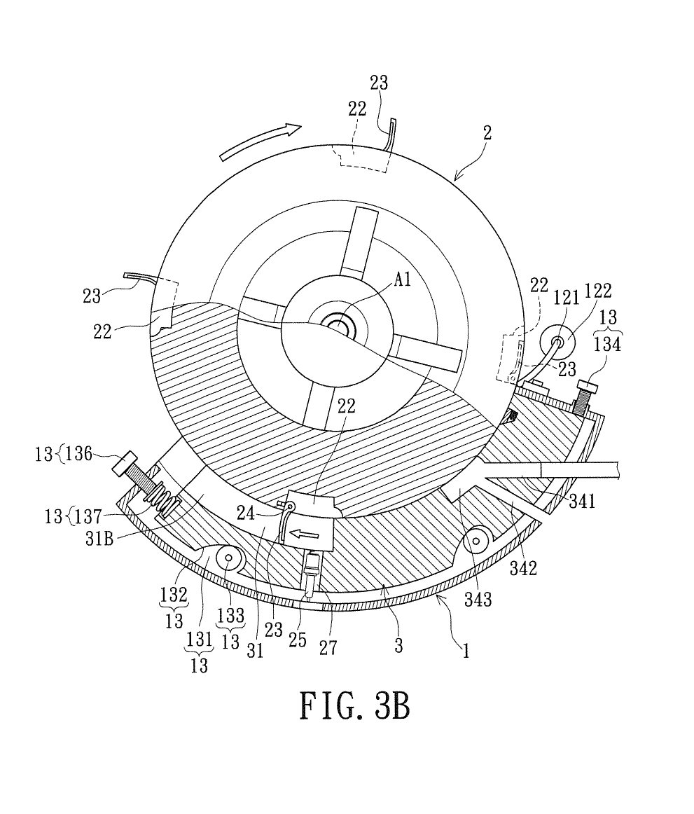

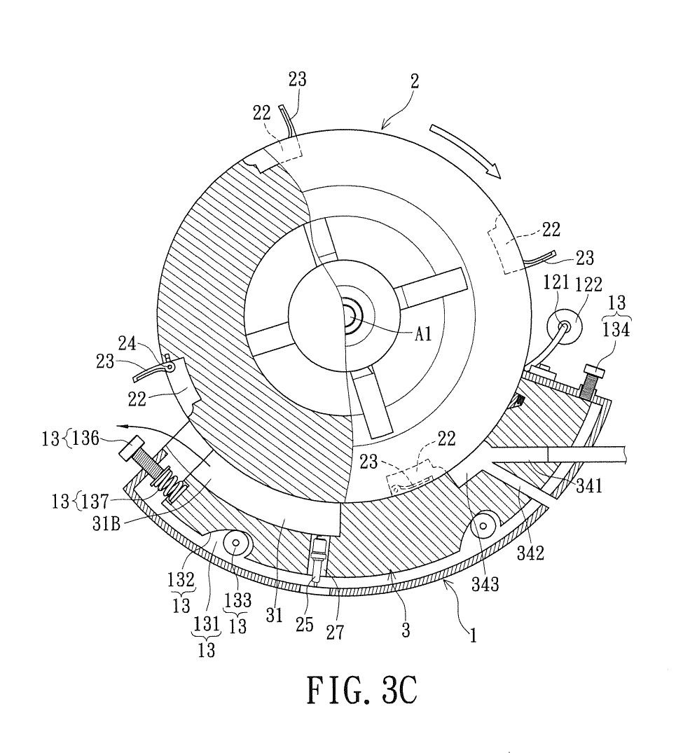

Please refer to FIG. 3A to 3C, the 2nd embodiment of the rotary engine is utilized for generator, prime motor, automobile, locomotive, airplanes, ships, vehicle or motorcycle. As shown in FIG. 3A, the rotary engine comprises a rotor 2 and a supporting member 3. The rotor 2 rotates around an axis A1 and has at least one chamber 22 disposed at radial edge of the rotor 2. Each chamber 22 has a U-shaped door 23 pivotally connected to the chamber 22, so that the door 23 can be selectively closed the chamber 22 by rotation around a shaft 24. In preferable embodiment, the door 23 or the shaft 24 are disposed at outmost of the chamber 22.

The supporting member 3 is disposed at radial side of the rotor 2, and approaches the rotor 2 (i.e. next to the rotor 2). The supporting member 3 has an inlet 341, a fuel intake 342, a spark plug 25 and a groove 31 disposed sequentially along with the rotated direction of the rotor 2 (by clockwise direction as shown in FIG. 3A), i.e. the inlet 341, fuel intake 342, the spark plug 25 and the groove 31 is sequentially disposed and spaced by an pre-determined angle. The groove 31 further has an outlet 31B disposed at outer edge of the supporting member 3 and connected to exterior of the fixing member 1. In preferable embodiment, the spark plug 25 is disposed in a trough 27 which is disposed inside the groove 31. Besides, the supporting member 3 is positioned by a fixing member 1, so as to combine the rotor 2 with the supporting member 3.

Moreover, the supporting member 3 has a preparative chamber 343 which connected to the end portion of the inlet 341 and the fuel intake 342. The inlet 341 guiding a compressed air into the mixing chamber 343, and the fuel intake 342 guiding a fuel into the preparative chamber 343, the fuel and the compressed air are mixed into a mixture gas. In preferable embodiment, the fuel may be gas, natural gas, petroleum gas, alcohol gas or mellow wine, etc. The preparative chamber 343 is disposed on the inner sidewall of the supporting member 3, thus the chamber 22 cross over the preparative chamber 343 the mixture gas enter the chamber 22.

As shown in FIG. 3B, when the rotor 2 rotates clockwise, then the spark plug 25 ignites the mixture gas of the chamber 22 wherein, the chamber 22 and the groove 31 are connected. In this manner, acute combustion (i.e. explosion) of the mixture gas is carried out inside the chamber 22 and the groove 31. while the chamber 22 may be close to the spark plug 25 and the groove 31. As shown in FIG. 3C,

As shown in FIG. 3B, after the mixture gas in the chamber 22 ignited, the door 23 is pushed and rotated by the explosion and the end portion of the door 23 is contacted and gasket to the inner wall of the groove 31, therefore the door 23 is pushed by the explosion gas inside the groove 31 and drives the rotor 2 rotated by clockwise direction.

As shown in FIG. 3C, after the door 23 departs the groove 31, the generated gas inside the groove 31 is exhausted from the outlet 31B to the exterior of the fixing member 1, and therefore the explosive force may drive the rotor 2 to rotate clockwise. By means of clockwise rotation of the rotor 2, the cycle as shown in FIG. 3A˜FIG. 3C including fuel entering, exploding and driving to rotation can be successively carried out.

In preferable embodiment as shown in FIG. 1, the supporting member 3 has at least one sealing component 35 infixed at periphery of the supporting member 3, so that the sealing components 35 may engage the rotor 2 when the rotor 2 is rotated. More specifically, the sealing components 35 are disposed between the rotor 2 and the supporting member 3, and therefore selectively seal up the chamber 22 and the groove 31. As showing in the FIG. 1, the sealing components 35 is disposed in two slots 351 disposed on the inner side of the supporting member 3, and several spring 352 disposed in the slots 351, so that the springs 352 can push the plate 35 to tightly seal up the rotor 2 and the supporting member 3. Summarily, the sealing components 35 may have diversified profiles.

### 3rd Embodiment

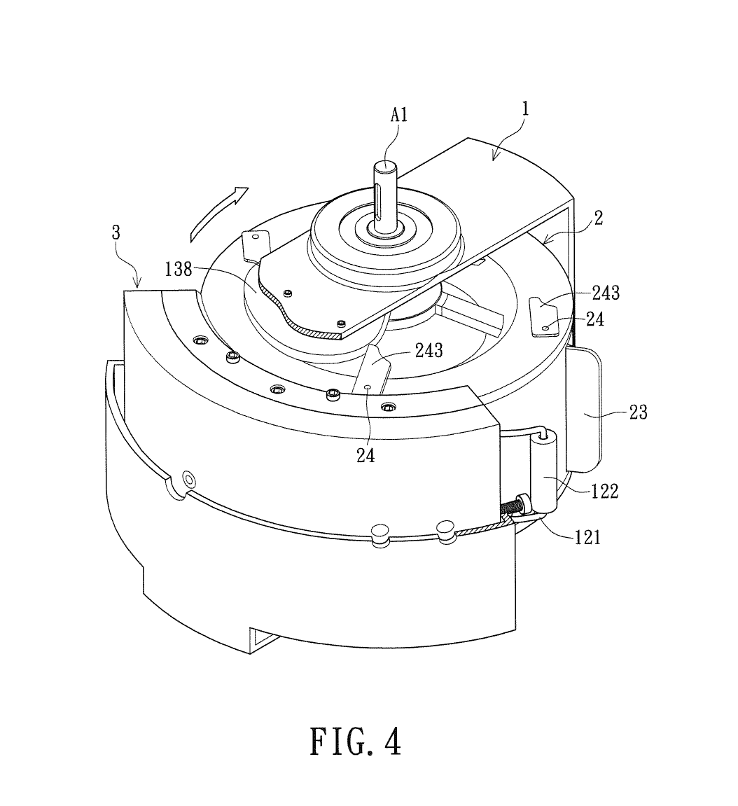

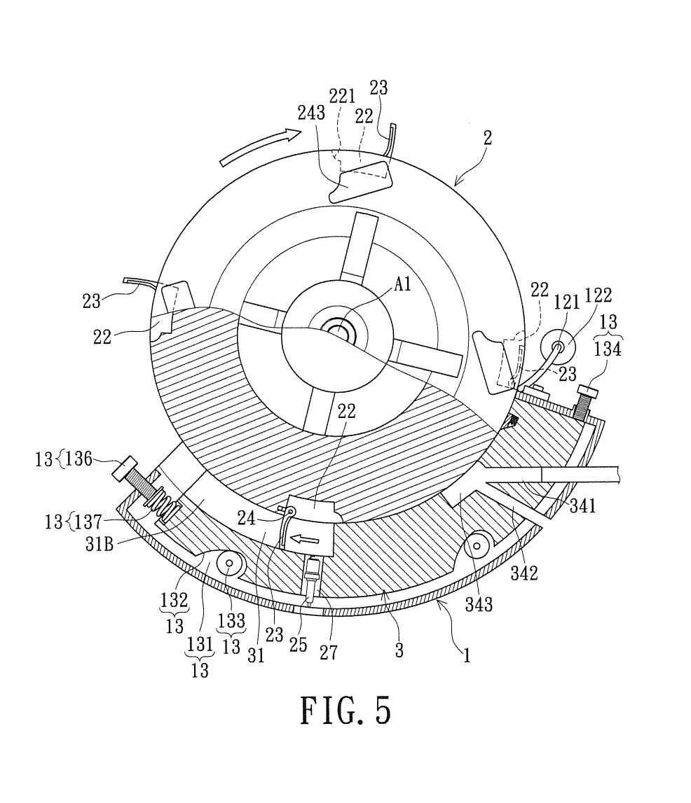

Please refer to FIG. 4 and FIG. 5, FIG. 4 and FIG. 5 are drawing of the 3rd embodiment of the rotary engine. As shown in FIG. 4, the door 23 further has a lever 243 connected with the shaft 24 of the door 23, so that the lever 243 can be simultaneously rotated with the door 23. The fixing member 1 further has a guiding member 138 disposed adjacent to the rotative path of the lever 243 and shaft 24 of the door 23. In preferable case, the curved surface of the guiding member 138 drives the lever 243 to ensure the shaft 24 and door 23 to rotate.

Referring to FIG. 5, the time it takes for the guiding member 138 pushing the lever 243 to rotate is when the fuel is ignited. In this manner, the lever 243 is force to rotate and the door 23 is ensured to be opened; no need to worry about that what exact ignition location is taken place, and whether the explosion is happened or not.

Summarily, the rotary engine of the present invention has totally new configuration which never seen before; the rotary engine has three steps (i.e. fuel entering, spark plug 25 ignition, and gas exhaust) it can be simultaneously so that the energy efficiency can be absolutely improve; namely, the energy conversion rate of the engine is better than traditional engine. It was overcoming to the closed turbine theory and Leading the world with a pioneer powerful mono-stroke engine.

The descriptions above only illustrate specific embodiments and examples of the present invention. The present invention should therefore cover various modifications and variations made to the herein-described structure and operations of the present invention, provided they fall within the scope of the present invention as defined in the following appended claims.

1. A rotary engine, comprising:
a rotor, rotating around an axis and having at least one chamber with a door selectively close the chamber;
one supporting member approaching the rotor and having at least one inlet, at least one nozzle, and a groove disposed sequentially along with the rotated direction of the rotor, the groove having an outlet connecting to exterior of the fixing member, the nozzle connected between the air inlet and the groove;
wherein the groove adjust the rotor and face to the chamber of the rotor, and the door approaching the groove, the door opened and rotated to a position which can contacted and gasket to the groove;
at least one sealing component disposed between the supporting member and approaching the rotor, the sealing component is infixed at periphery of the supporting member or at periphery of the groove, and the sealing component has a plate and at least one spring pushing the plate to seal up the rotor;
wherein the inlet allows a working gas entering the groove and approaching the chamber; and pushed the door and the rotor to rotated.

2. The rotary engine of claim 1, having a pin valve which extended into the nozzle to adjust the flow of the working gas.

3. The rotary engine of claim 1, wherein the working gas is selected from compressed air, steam, or combustion gas.

4. The rotary engine of claim 1, wherein the fixing member having at least one tuning component, the tuning component include a first adjusting screws and a second adjusting screws disposed on two end of the fixing member, and a spring disposed between the supporting member and the second adjusting screws, and a plurality of cam slots disposed on the outer edge of the supporting member, a plurality of rollers engaged in the inner side of the cam slots, each of the roller is adjusted the curved surface of the cam slots.

5. A rotary engine, comprising:
a rotor, rotating around an axis and having at least one chamber with a door selectively close the chamber;
one supporting member approaching the rotor and having a inlet, a fuel intake, a spark plug and a groove disposed sequentially along with the rotated direction of the rotor, the groove having an outlet connecting to exterior of the fixing member, the inlet and the fuel intake connected to a preparative chamber, the inlet conducting a compress air into the preparative chamber, and the fuel intake guiding a fuel into the preparative chamber, the fuel and the compressed air are mixed into a mixture gas, the preparative chamber disposed on the inner sidewall of the supporting member, thus when the chamber of the rotor cross over the preparative chamber, the mixture gas inject into the chamber;
wherein the groove adjust the rotor and face to the chamber of the rotor, and the door approaching the groove, the door opened and rotated to a position which can contacted and gasket to the groove;
at least one sealing component disposed between the supporting member and approaching the rotor, the sealing component is infixed at periphery of the supporting member or at periphery of the groove, and the sealing component has a plate and at least one spring pushing the plate to seal up the rotor;
wherein the chamber approaching the groove, the mixture gas carried by the chamber flow into the groove and ignited by the spark plug, the door is pushed and rotated by an explosion made from the mixture gas, the door contacted and gasket to the groove, thus the door and the rotor pushed by the explosion made from the mixture gas.

6. The rotary engine of claim 5, wherein the fixing member having at least one tuning component to adjust the location of the supporting member and the clearance between the supporting member and the rotor; the tuning component include a first adjusting screws and a second adjusting screws disposed on two end of the fixing member, and a spring disposed between the supporting member and the second adjusting screws, and a plurality of cam slots disposed on the outer edge of the supporting member, a plurality of rollers engaged in the inner side of the cam slots, each of the roller is adjusted the curved surface of the cam slots.

7. The rotary engine of claim 5, wherein the door is pivotally connected to the chamber.

8. The rotary engine of claim 5, wherein the door is disposed at outmost of the chamber.

9. The rotary engine of claim 5, wherein the spark plug is disposed near the groove or at the periphery of the groove.

10. The rotary engine of claim 5, wherein the chamber is disposed at the axial edge of the rotor or radial edge of the rotor.

11. The rotary engine of claim 5, wherein the supporting member is disposed at the axial side of the rotor or radial side of the rotor.

12. The rotary engine of claim 5, wherein the chamber has a conducting valley disposed at surrounding of the chamber.

13. The rotary engine of claim 5, wherein the rotary engine further has a guide to drive the door to close when the door approaches the supporting member and in due course.

14. The rotary engine of claim 5, wherein the rotary engine further has a plurality of levers connected with several rotation shafts of the doors, and at least one guiding member disposed adjacent to the rotative path of the door, so that the roller pushes the door to rotate and open.
